(19) United States
(12) Patent Application Publication
(10) Pub. No.: US 2024/0308906 A1
(43) Pub. Date: Sep. 19, 2024

(54) TARGETED ADDITION OF GRINDING AIDS DURING A GRINDING PROCESS

(71) Applicant: CEMEX INNOVATION HOLDING AG, Zug (CH)

(72) Inventors: Julien CHAPELAT, Biel/Bienne (CH); Oliver Armando AGUILAR MARTINEZ, Biel/Bienne (CH)

(21) Appl. No.: 18/264,235

(22) PCT Filed: Feb. 5, 2021
(86) PCT No.: PCT/EP2021/052742

§ 371 Date: Aug. 3, 2023

(51) Int. Cl. C04B 7/52

(52) U.S. Cl. CPC C04B 7/527

(57) ABSTRACT

The present invention concerns an improved method of grinding or milling fresh feed (i.e. crushed yet not milled clinker (with or without additions)), using two different grinding agent systems added at specific locations of the cement grinding mill, preferably at two different locations of a cement ball mill, depending on the particle size or fineness of the material to be ground, to reduce the energy needed to achieve a targeted cement fineness or increase the fineness of the cement at constant energy consumption.

### TECHNICAL FIELD OF THE INVENTION

The present invention relates to an improved method of grinding or milling a fresh feed (i.e. crushed yet not milled clinker (with or without additions)), using two different specific grinding agent systems added at specific locations of the cement grinding mill, preferably at two different locations of a multi-chamber cement ball mill, depending on the particle size or fineness of the material to be ground, which can be clinker or clinker and additions (limestone, slag, pozzolans, fly ash, calcined clay, gypsum, etc.). This reduces the energy needed to achieve a targeted cement fineness or increase the fineness of the cement at constant energy consumption.

Problem to Solve: The traditional grinding process in cement manufacturing process is a high energy intensive process, which indirectly leads to a high carbon footprint. The inventors have discovered that, adding selected different grinding aids at specific locations of the grinding process greatly improves the efficiency of the overall process, reducing its energy impact, compared to conventional usage of grinding aids or mixes, added in one single location of the grinding process.

### STATE OF THE ART

The final processing stage in cement manufacturing is the grinding of the clinker nodules that are produced in the kiln system. This grinding step is done in a cement mill, which can be one of four types: ball mill, vertical roller mill, roller press or horizontal mill.

The purpose of the cement mill is to ground the clinker and any additions (for example, pumice, gypsum, limestone, pozzolans, etc.) into a fine powder, which increases the surface area and consequently the reactivity of the cement with water for concrete or mortars production.

The grinding step is a high energy intensive process, as the average size of the particles reduces from some centimetres before grinding to 20-40 microns (final size after grinding). The energy efficiency of grinding or milling is very low, typically located between 25 and 40 KWh/t depending on the material grindability, product fineness and plant efficiency. A common method to increase the grinding efficiency is by adding grinding aids, which bond to the clinker particles increasing their flowability, consequently increasing the size reduction rate. The improved grinding efficiency is demonstrated either by achieving a finer material with a given energy, or by reducing the required energy to achieve a given fineness. Despite this common practice, the grinding process is still highly energy demanding, accounting for around 40% of the total energy consumption at a cement plant.

It was found that the grinding efficiency can be further improved by adding two distinct sets of grinding aids at two different locations on the grinding process. The location where each grinding aid set is added depends on the fineness of the clinker particles at that stage.

A more efficient grinding process reduces the process' energy demand, indirectly leading to a reduction in CO₂ emissions, or it allows to obtain a higher fineness of the milled cement using the same energy input, which increases the reactivity of the cement.

Concrete is the most widely used building material in the world. Cement, being the main component of concrete, plays a crucial role in the economic development of today's world and it is used in all types of constructions: residential, commercial and infrastructures. Therefore, it is easily understood that a high activity in the construction sector translates into a high cement demand and consequently, into an increase in cement production.

To meet the market demand, cement companies need to ensure continuous, economic and high-quality cement production.

The main step in the cement production process consists of heat treating a mixture of materials (limestone, clay, iron ore, among others) called raw meal. The most important elements in this mixture are silicon, aluminium, iron and calcium but also minor quantities of other substances are present, such as sulphur, magnesium, sodium, potassium, etc. The raw meal preparation includes firstly the steps of drying, crushing and grinding. Then, the raw meal is fed into the pre-heater, where it is gradually heated up from approximately 200° C. to 900° C., so that the CaCO₃ present in the raw meal converts into CaO and CO₂. Subsequently, the calcined material (hot meal) enters the kiln and it is heated up from 900° C. to 1500° C. (sintering phase). This is a crucial step to produce the main component of cement: clinker, a dark grey nodular material. The clinker contains minerals that are responsible for the unique properties of cement, said minerals being tricalcium silicate (Ca₃SiO₅, alite), dicalcium silicate (Ca₂SiO₄, belite), tricalcium aluminate (Ca₃Al₂O₆) and tetra-calcium aluminoferrite (4CaO·Al₂O₃Fe₂O₃). After being produced, the clinker is cooled and stored until it is turned into cement in a cement mill.

The cement mill transforms the clinker particles and any additions into a fine powder. There are four main types of cement mills: ball mill, vertical roller mill, roller press or horizontal roller mill.

In a ball mill, particle's size is reduced through impact and attrition. As the name indicates, this type of mill has balls inside which, as the mill rotates, turn and drop from near the top of the mill's shell into the particles. Ball mills normally have two chambers but can have as many as four chambers (two to four chambered ball mills are generally referred to as multi-chamber ball mills). The material to be ground enters the first chamber which uses larger balls (60-80 mm in diameter) to crush the clinker nodules. When the particles reach a certain size reduction, they enter the second chamber, where the balls typically have a diameter ranging between 15 and 40 mm, in order to produce the desired ultra-fine particles. The percent of volume occupied by the balls in a given chamber is called the fill factor, having an optimum value for cement grinding between 26-30%. When the balls are very worn due to abrasion, they must be replaced to maintain this factor.

The fresh feed (or raw mill feed; which is a stream of crushed yet not milled material entering the ball mill for the first time and comprising a mix of different components (e.g. mainly clinker but also gypsum and additions) used in the cement type recipe) particles leave the silos (1) and are transported through weight feeder/conveyor belt(s) (2) to the mill fresh feed chute (3). The grits return line (10), which is a conveying system carrying the tails from the separator pneumatically or by belt conveying, transports the coarse reject or “grits” from the separator (15) and discharges them at the mill fresh feed chute (3). Fresh feed and return grits from the separator (15) are ground in the first chamber (4) until no more than 1 wt. % of the particles are retained on 1 mm sieve and not more than 50 wt. % of the particles are retained on a 90 μm sieve. The large grain size particles are screened by an intermediate diaphragm (5), wherein finer particles (<6 mm) pass into the second chamber (6). The ground particles in the second chamber (6) reach the discharge diaphragm (7) at the end of the second chamber (6) with an approximate fineness of 40 wt. % retained on 45 microns or an approximate Blaine of 2200 cm²/g and are lifted to be transported to the drop-out-box (8) where a small portion of the fine particles is lifted through the mill filter line (20) to the mill filter (22) by the air draft created by the mill fan (23). The collected filtered material on (22) is returned by a screw conveyor (21) and subsequently through a discharge duct (19) to the mill outlet air slide (9) (the air slide is a pneumatic conveying system designed to transport powdered materials) where it joins the discharged material from the mill and both are transported to the bucket elevator (14) which lifts the material to the air classifier or separator (15). The returned material, called return grits, are returned from the separator (15) via grits return line (10) to the mill fresh feed chute (3) and the fine dust exhaust from the separator (16) is collected in a dust collecting filter (17) that is assisted by a separator fan (18). The material collected by the dust collecting filter (17) is transported by a screw conveying system (24) to the finish product silo. In a ball mill, one also finds a low speed coupling, that transmits power, accommodates missed alignment and compensates for axial movement (11), a gear box, which is a mechanical device used to increase the output torque and the speed of the mill (12) and a motor, which converts the electrical energy into mechanical energy, wherein the power installed in the motor is the one that determines the mill capacity (13).

Inside the mill, an air flow moves the material from the first chamber (4) to the second chamber (6) and subsequently to the discharge diaphragm (7). This air flow reaches different velocities inside the mill-around 1.5 m/second in the first chamber (4), 0.8 to 1.5 m/second in the second chamber (6) and 15 m/second over the intermediate diaphragm (5). Normally, fine particles and return grits experience very little processing in the first chamber, due to the reduced contact between material and grinding balls, which are designed to crush large particles. Therefore, smaller particles move faster into the second chamber (6).

When the material reaches the intermediate diaphragm (5), a series of apertures located at the walls of the diaphragm stop particles bigger than 6 mm. The larger material remains in the first chamber to be further ground. When the particles are fine enough, they go through the apertures of the intermediate diaphragm (5) and are discharged into the second chamber. When the material reaches the end of the second chamber, it is lifted by a diaphragm called discharge diaphragm (7) to the mill outlet air slide (9) and from there it is conveyed to the bucket elevator (14) (or the pneumatic transport) to be delivered to the separator (15). There, fine classified particles are re-directed to the dust collecting filter (17) and after to the finish cement silo, while larger particles are returned to the mill inlet, forming the return grits.

The return grits are finer than the material passing the intermediate diaphragm (5) into the second chamber (6), typically having an approximate fineness where no more than 80 wt. % of the particles are retained on 45 μm sieve and not more than 50 wt. % of the particles are retained on a 90 μm sieve (Blaine comprised between 900 cm²/g and 1200 cm²/g.

We refer to Bhatty, Miller, Kosmatka, Bohan, “Innovations in Portland cement Manufacturing”, SP400; Portland Cement Association, Skokie, Illinois, U.S.A, 2011 for more information on ball mills.

Despite being one of the most used mills in the cement manufacturing process, especially due to their low cost, these mills have a poor efficiency. Ball mills have a very high specific power consumption and a low power utilization (about 55 kWh/ton to a Blaine between 3,900-4,100 cm²/gr, or 14-16 wt. % are retained on a 45 μm sieve, depending on the material to be ground), with the energy being lost as heat as the balls collide with themselves and the mill's wall. This low efficiency led to the development of other mill technologies, such as: vertical roller mils, roller press mils or horizontal roller mills (Horomill). These mills are generally more efficient than ball mills, but they also have disadvantages such as cost and higher maintenance, cost of installation, product quality or versatility.

To increase such efficiency, ball mills are normally operated in a closed circuit, the return grits being returned several times to the mill. In normal conditions, the fresh feed represents only ⅓ in weight of the total material entering the first chamber (4) of the mill whereas the other ⅔ in weight is represented by the return grits coming from the separator (15).

Another common practice to increase the efficiency in ball mills is to add grinding aids.

The addition of grinding agents or “grinding aids” is a common practice in the cement industry, to increase grinding efficiency and decrease energy consumption, leading to a more sustainable process.

Grinding aids improve the powder flowability and the fineness of the final product. Fineness is an important parameter for the quality of the final product. A cement with finer particles will be more reactive, leading to less water required in the concrete's preparation, while improving its workability.

Grinding aids adsorb on the surface of the freshly grounded particles, neutralizing the electrostatic forces present on their surface which prevents agglomeration. Consequently, the dispersion of the particles is improved.

The inventors have discovered that the chemistry of the grinding aid together with the method of adding such grinding aids in the ball mill play a role in the overall efficiency of the process. It was discovered that, selecting two sets of different grinding aids and adding them at specific locations of the grinding process, according to the particles' size, significantly improves the grinding efficiency.

A specific type of grinding aid may enhance the grinding process mostly in an initial stage, while another grinding aid will improve grinding efficiency mostly at a later stage in the process, when particles are finer. It turns out that, when those specific grinding aids are mixed and added simultaneously, as it is commonly done by the man of the art, the grinding performance is not maximized. Alternatively, when those same grinding aids, with the same dosages, are added separately depending on the clinker particles' fineness, their enhancing effect is better, and the overall grinding performance is boosted.

WO2020173927 has recently described a similar method to grind a hydraulic binder wherein the binder and also a grinding aid B (GAB) are added to the first chamber of a ball mill, together or separately. The composition obtained is discharged into the second chamber where a second grinding aid (GAA) is introduced. The grinding aid GAB comprises a polyol, an alkanolamine or a mix of both, whereas the grinding aid GAA is an alkanolamine. This means that both GAA and GAB can be the same chemical (alkanolamine). Furthermore, WO2020173927 teaches that an alkanolamine should be used as GAB when the binder is “soft”; in this case, “polyols could induce a harmful agglomeration for grinding and should therefore be avoided.” Yet, there is no definition of “soft”.

WO2020173927's inventors believe that the alkanolamine has a fluidifying effect, increasing the flow of the small sized binder particles, facilitating the removal of those small particles from the mill. On the other hand, GAB increases the binder's residence time in the crusher.

The present invention does not aim at increasing the fluidity of the cement particles and therefore to increase the efficiency of the separator. Similar to WO2020173927, the present invention proposes to add the different grinding agent systems (also named grinding aids below) in specific locations, preferably in two different locations, of the grinding cement mill, but it was found that it is much more efficient to add a first grinding aid in the feeder/conveyor belt(s) (2) and/or in the mill fresh feed chute (3), instead of directly into the first chamber of the ball mill as described in WO202017392. It was also found that it is more efficient to add a second grinding aid, different from the first one, in the mill fresh feed chute (3) or alternatively much more efficient to add it in the grits return line (10), instead of adding it directly in the second chamber, which is not disclosed in WO2020173927. When added in the mill fresh feed chute (3), the second grinding aid can optionally be added also to the grits return line (10). Additionally, it was discovered that the molecular weight of the grinding aids used and the number of heteroatoms in its molecular structures play a role in the whole efficiency of the grinding process. It was discovered that, molecules with molecular weight greater than 110 g/mol and simultaneously having at least 4 heteroatoms that include at least one oxygen or hydroxyl in their molecule structure, have a better affinity to the surface of the fresh feed particles, whereas molecules with molecular weight between 46 g/mol and 110 g/mol and a maximum of 3 heteroatoms, where at least one of those is an oxygen atom, have a better affinity to the smaller particles. This implies that, according to the present invention, molecules such as Glycerol, Ethylene Glycol (EG) or Diethylene glycol (DEG) that have characteristics such as a molecular weight between 46 g/mol and 110 g/mol and a maximum of 3 heteroatoms, where at least one of those is an oxygen atom, can be used as grinding agents for the smaller particles, which goes completely against the teachings of WO2020173927. According to WO2020173927, polyols are used in the first grinding chamber, which majorly processes the bigger particles. Also, molecules such as formic or acetic acid can be used solely as grinding agents for the smaller particles, which also goes against the teachings of WO2020173927, wherein such acids or their salts can only be used together with an alkanolamine.

The other methods described in the prior art to increase the efficiency of the grinding process always revolve around adding one or a mixture of grinding aids together into the ball mill and completely differ from the present solution, which describes adding such grinding aids separately in two different locations of the grinding process. Even so, we briefly describe some of the prior art below.

Prziwara et al. (“Impact of grinding aids and process parameters on dry stirred media milling”, Powder Technology, Volume 335, 15 Jul. 2018, Pages 114-123) studied both the mill parameters and the addition of grinding aids to improve the grinding process of limestone and concluded that the mill's parameters should be adjusted according to the grinding aid used. The possibility of adding grinding aids of various molecular sizes according to the fineness of the particles to be ground was not considered.

EP2980036A1 discloses a method of manufacturing a cement from a clinker which has at least two kinds of clinker phases with differing grindability. The method is accomplished by grinding cement clinker in the first milling stage and after, the particles are transferred to a first separator which divides the material into a first fraction with a predetermined maximum particle size and a second fraction with a larger particle size. The second fraction with a larger particle size is transferred to a second milling stage to be grinded to the final particle size. The type of grinding aids used in WO2020173927 is also different than the type of admixtures used in our invention.

This invention discloses a separation method for grinding clinker with different grindability, wherein its focus is in the mechanical homogenization of the particles to be ground through two different grinding stages, whereas the present invention discloses a new method of using known grinding aids to chemically improve the grindability of clinker and additive particles.

U.S. Pat. No. 7,922,811 describes the use of polyols, preferably low molecular weight diols and/or triols which are derived from the conversion of biomass sources (“biomass-derived polyols”), and its advantages when compared to glycerins derived from fossil fuel sources for enhancing the efficiency of grinding processes. This biomass-derived polyol-containing composition may be added separately or together with one or more conventional cement grinding aids, and/or one or more conventional cement quality improvers (e.g., cement hydration control agent), and/or other cement additives such as hexavalent chromium reducing agents and added into the grinding mill operation during or before the grinding of the particles. U.S. Pat. No. 7,922,811 discloses a new source of grinding aids derived from Biomass instead of fossil fuel sources, which are used on a conventional manner.

The present invention does not aim at disclosing a new grinding aid, but instead targets a new method of using known chemicals to improve the efficiency of the overall grinding process.

U.S. Pat. No. 3,615,785 relates to additive compositions for use as grinding aids and pack set inhibitors in the manufacture of hydraulic cements and to hydraulic cements containing these compositions.

It has been found that by intergrinding small quantities of an additive composed of a water-soluble polyol and a water-soluble salt of an aliphatic acid having no more than three carbons with cement particles unexpectedly produces a synergistic effect which increases the grinding efficiency of the clinker and retards pack set of the cement to a degree that is unattainable using the additives separately.

Also, an amine accelerator, salts of sulfonated lignin and/or urea can be added to the aforementioned additive to produce desirable additional improvements.

CN1749195 uses triisopropanolamine as a cement grinding aid directly, or together with triethanolamine, an auxiliary agent and water in the following percentages: 40-100% of triisopropanolamine, 0-15% triethanolamine, 0-25% of auxiliary agent and 0-30% of water. The auxiliary agent is one or more of a carboxylic acid, a lignosulfonate, and an alkylsulfonate. The carboxylic acid is preferably C4 or less.

U.S. Pat. No. 10,077,211B2 mentions a cement grinding aid prepared by using waste antifreeze. The cement grinding aid comprises the following components by weight: 20-75 parts of pretreated waste antifreeze, 5-40 parts of alkanolamine, 1-5 parts of an acid solution, 3-12 parts of saccharide and 15-50 parts of water. The pre-treatment of the waste antifreeze is: adding an alkaline solution into the waste antifreeze to adjust the pH value, then adding flocculant, stirring and standing; separating the upper layer oil, then filtering for removing the flocculent precipitates, and obtaining the clear mixed solution.

The prior art focus on new chemicals that can be used as grinding aids, which are mixed with the mill contents in the beginning of the grinding process, either onto the mill fresh feed or directly into the mill itself. When more than one chemical is added, the man skilled in the art will mix them and add them simultaneously into the mill.

In contrast, the present invention discloses a method to use conventional grinding aids, by adding them at specific locations of the overall grinding mill (see FIG. 1), depending on the particle size or fineness of the material to be ground. The inventors have discovered that, in doing so, a more efficient grinding process is achieved which allows to reduce the required energy to achieve a targeted cement fineness or increase the fineness of the cement at constant energy consumption.

One advantage according to the invention is that the costs of grinding aids is not increased as conventional cheap chemicals can be used in conventional dosages compare to the use of high costs chemicals described in prior art to enhance the milling efficiency.

### DESCRIPTION OF THE INVENTION

The inventors have discovered that adding commonly used grinding additives in specific locations [in feeder/conveyor belt(s) (2) and/or mill fresh feed chute (3) and/or grits return line (10)] of the cement grinding mill, greatly improves the overall efficiency of said grinding process.

The present invention describes a method to increase the grinding efficiency of a fresh feed (i.e. fresh feed particles and/or fresh feed particles and return grits particles) during cement manufacturing process in the finish cement mill, comprising:
a) Providing a fresh feed to a multi-chamber cement ball mill, comprising clinker, gypsum and additions.
b) Adding a first grinding agent system to the fresh feed, wherein the fresh feed's particles have a fineness characterized in that 50% or less of said particles pass through a 1 mm sieve;
c) Adding a second grinding agent system, which is different from the first grinding agent system, to the return grits in the grits return line, wherein the grinding agents that comprise the second grinding agent system are characterized in that they have a molecular weight between 46 g/mol and 110 g/mol and they have a maximum of 3 heteroatoms where at least one of them is oxygen;
d) Grinding the material obtained in step b) and c) until the material reaches a fineness characterized in that not more than 1 wt. % of the particles are retained on a 1 mm sieve and not more than 50 wt. % of the particles are retained on a 90 μm sieve;
e) Further grinding the material obtained in step d) until the material reaches a fineness of 40 wt. % retained on a 45 μm sieve.

The present invention also describes an alternative method to increase the grinding efficiency of a fresh feed (i.e. fresh feed particles and/or fresh feed particles and return grits particles) during cement manufacturing process, comprising:
a) Providing a fresh feed to a multi-chamber cement ball mill;
b) Adding a first grinding agent system and a second grinding agent system, which is different from the first grinding agent system, to the fresh feed;
wherein the fresh feed's particles have a fineness characterized in that 50% or less of said particles pass through a 1 mm sieve; and
wherein the grinding agents that comprise the second grinding agent system are characterized in that they have a molecular weight between 46 g/mol and 110 g/mol;
c) Optionally adding the second grinding agent system to the grits return in the grits return line;
d) Grinding the material obtained in step b) and optionally in step c) until the material reaches a fineness characterized in that not more than 1 wt. % of the particles are retained on a 1 mm sieve and not more than 50 wt. % of the particles are retained on a 90 μm sieve;
e) Further grinding the material obtained in step d) until the material reaches a fineness of 40 wt. % retained on a 45 μm sieve.

In step a) of the methods (method and alternative method) of the present invention, fresh feed is provided to a cement ball mill. This cement mill is preferably a two-chamber ball mill.

In step b) of the methods (method and alternative method) of the present invention, the grinding agent system is added to the fresh feed particles that have a fineness characterized in that 50 wt. %, preferably 70 wt. %, even more preferably 80 wt. % or more of said particles are retained in a 1 mm sieve. Hence, the addition of the grinding agent system is preferably done in the conveying belt of the fresh feed (2). Alternatively, the addition of the grinding agent system can be done in the mill fresh feed chute (3) prior entering the ball mill, provided that the fineness of the material receiving the grinding aid is verified, or simultaneously in both the conveying belt of the fresh feed (2) and in the mill fresh feed chute (3) prior entering the ball mill.

According to a particular embodiment of the methods (method and alternative method) of the present invention, the grinding agents that comprise the first grinding agent system added in step b) are characterized in that they have a molecular weight above 110 g/mol and has 4 or more heteroatoms, where at least one of them should be oxygen.

It was observed that grinding agents with bigger molecular structures, meaning molecules with a molecular weight greater than 110 g/mol and simultaneously having at least 4 heteroatoms that include at least one oxygen or hydroxyl in their molecular structure, have a better affinity to the surface of the fresh feed particles, increasing the grindability of these particles without causing any detrimental effects in the quality of the final product, such as strength loss, different setting time or increase in the pack set. The inventors verified that there was a threshold regarding the molecular weight affecting the grinding efficiency of the fresh feed particles; the best performing molecules were the ones with a molecular weight above 110 g/mol. These types of molecules are more efficient in coating the fresh feed particles, dispersing those particles even at larger distances.

Furthermore, due to the hydroxy group (OH⁻) present in their molecular structure, these grinding agents that comprise the first grinding agent system have the capability to electrostatically interact with the surface of the different materials that make up the cement mill fresh feed (namely clinker, gypsum and additions), which are introduced in the cement mill to be ground. Moreover, if this first grinding agent system comprises an amine group in their molecular structure, said amine provides an additional free charge on the nitrogen, representing an additional attachment possibility to the fresh feed particle, providing extra support in neutralizing charges, further increasing the interaction between grinding agent and fresh feed particles or additions.

Once the grinding agent molecule is in contact with the surface of the fresh feed particles, it bonds with it and the particle is dispersed due to the friction, impact and attrition forces present during the grinding. As the fresh feed particles experience size reduction, their surface area increases, and free charges start to be created on the newly fresh exposed areas. By interacting with the surface of the different materials, the grinding additive starts to support the dispersion of the particles by neutralizing the electrostatic forces present on their surface, preventing re-agglomeration.

Preferably, the first grinding agent system is added in step b) in a dosage between 0.01% and 0.5% by weight of the particles to be ground. This minimum dosage (0.01% by weight of particles to be ground) ensures that the number of grinding aid molecules in the mix per surface area is enough to start interacting with the fresh feed particles, outweighing the attraction forces between them. A dosage higher than 0.5% by weight of the particles to be ground is not recommended, as it starts to negatively impact the quality of the final product.

In step d) of the methods (method and alternative method) of the present invention, the grinding agent system(s) added in step b) and (optionally) in step c) is ground with the particles of the material until the material reaches a fineness characterized in that not more than 1 wt. % of the particles are retained on and above a 1 mm sieve and not more than 50 wt. % of the particles are retained on and above a 90 μm sieve.

In step e) of the methods (method and alternative method) of the present invention, the material moves into the second chamber of the ball mill and it is ground until the desired final fineness is obtained. This final fineness depends on the type of cement that is being manufactured. For CEM I 52.5R<3 wt. % retained on 45 μm or 75 wt. % passing 30 μm, CEM I 42.5R 9.5 wt. % retained on 45 μm, CEM II 6.5 wt. % retained on 45 μm and CEM III 4.5 wt. % retained on 45 μm.

The material is then discharged from the mill and goes into the separator (15). The material that complies with the desired fineness is discharged into the finish product silo; the material that still needs further processing is returned to the first chamber of the ball mill via the returns grit line (10).

In step c) of the methods (method and alternative method) of the present invention, the second grinding agent system is added in the returns grit line (10). Since the material obtained in step d) has a fineness characterized in that not more than 1% of the particles are retained on and above a 1 mm sieve and not more than 50 wt. % of the particles are retained on and above a 90 μm sieve, this second grinding agent system is preferably added directly in the grits return line (10) transporting the return grits from the separator (15) to the ball mill entrance of the first chamber (4), by means of an injection lines and nozzles and respective dosing system. It was observed that the second grinding aid is efficient if added together with the first grinding aid in the fresh feed, and is much more efficient if added in the returns grit line (10), instead of directly in the second grinding chamber. A proposed theory, in the second case, is that the particles in the returns grit line (10) have already passed through the separator (15) where smaller particles that comply with the final product specification were sent to the final product silo, and bigger particles that still needed to be further processed were sent to the returns grit line (10). Hence, if the second grinding additive is added in the returns grit line (10), the additive is immediately in contact only with said particles that still need to be further processed. The second additive, which has a molecular weight between 46 g/mol and 110 g/mol and has a maximum of 3 heteroatoms (where at least one of them should be oxygen), has a very high affinity to all those particles in the returns grit line (10) and coats said particles. When the particles enter the first grinding chamber to be re-processed, they are completely coated with the second grinding additive and suffer already some re-processing in the first grinding chamber. As the size reduction continues in the second grinding chamber, newly fresh exposed surfaces are created As the particles roll on each other, they interact more, experiencing attrition forces. The second grinding agent is effective due to its small size and molecular weight—the forces between finer particles are stronger at shorter distances, therefore small molecules are more effective at this stage.

Adding the second admixture in the grits return also presents technical advantages by its simplicity compared to injection the second admixtures in the second chamber of a rotating drum, requiring less piping and enabling a much easier maintenance as all parts are directly accessible.

Preferably, the second grinding agent is added in step c) in a dosage between 0.01% and 0.5% by weight of the particles to be ground. A lower dosage than 0.01% by weight of the particles to be ground leads to poor coverage and poor charge neutralization, decreasing the dispersive effect. Overdosing leads to an extremely fluid material, which will negatively impact the grindability of the material and the quality of the final product.

Preferably, the total weight % of the said first and second grinding agent is between 0.02% and 1.0% by weight of the total particles to be ground.

The performance of the additives is strongly dependent on the total dosage; under-dosing (less than 0.02%) leads to poor coating of the fresh feed particles and poor charge neutralization, decreasing the dispersive effect. Overdosing leads to an extreme fluid material which impact negatively the grindability of the material and also affects the quality of the cement.

### Definitions

Hydraulic binder. It is a material with cementing properties that sets and hardens due to hydration even under water. Hydraulic binders produce calcium silicate hydrates also known as CSH.

Cement. It is a hydraulic binder comprising milled or ground clinker, gypsum and various possible mineral additions like limestone, fly ash, slag, pozzolanic materials, calcined clay, etc. that sets and hardens when mixed with water, bringing the materials together. Cement is made from grinding clinker with gypsum and additions.

Cement grinding process. Process carried out in a cement manufacturing plant in which the hard, nodular clinker from the cement kiln is ground together with gypsum and additions into the fine grey powder that is cement. The process is normally continuous and is carried out in a cement mill.

Clinker. Nodular material produced by sintering limestone and aluminosilicate materials such as clay in a cement kiln.

Concrete. Building material made from a mixture of cement, sand, aggregates and water (and optionally admixtures) which can be spread or poured and then it sets/hardens.

Concrete workability. Property of freshly mixed concrete which determines the ease and homogeneity with which it can be mixed, placed, consolidated and finished’ (ACI Standard 116R-90).

Cement paste. Mixture of cement and water.

Hydration. Process wherein cement reacts with the water and causes concrete to harden and set. It is a chemical reaction wherein cement bonds with water molecules originating hydration products.

Admixtures. Also referred as concrete admixtures. Chemicals which can be natural occurring or manufactured and are added to concrete before setting. Examples of concrete admixtures are air-entraining agents, water reducers, water-reducing retarders and accelerators.

Sintering. Process in which a material is formed by heat or pressure without melting.

Cement kiln. Consists of a rotary tube made from steel plate, and lined with firebrick, used for the pyroprocessing stage of manufacture of Portland and other types of hydraulic cement.

Gypsum. A soft white or grey mineral consisting of hydrated calcium sulphate.

Additions: Materials added to the cement besides gypsum to conform the total amount of binder, it includes gypsum, limestone, pozzolans as shown in the European cement standard EN 197. They work on the optimization of the cement properties and the cement grinding process.

Cement mill. A cement mill is the equipment used in the continuous cement grinding process to grind the clinker from the cement kiln into the fine grey powder that is cement. Fresh feed. Stream of material that enters the ball mill. This material comprises mainly clinker but also gypsum and additions.

Closed circuit. When the mill operates using a closed circuit with a return stream, the particles pass through the mill several times, leaving the mill and re-entering through the return.

Circulation load. The ratio of the number of solids going through the ball mill divided by the total amount of solids going through the circuit.

Grinding agent. Also called grinding aid, grinding agent or grinding additives. Chemical components added to clinker to aid in the reduction process of the clinker into powder.

Flowability. Ability of a powder to flow under a specified set of conditions, for example the pressure on the powder, the humidity and the type of equipment where the powder is flowing.

Blaine. Is a standard test method for powdered material to measure of the fineness of a powdered material, such as cement, usually expressed as a surface area in square centimeters per gram.

Fineness. Estimation of how fine a powdered material is. Normally measured by passing the material through sieves with different mesh sizes and registering how much of said particles are retained and how much pass through. Laser granulometry or Blaine test can also be applied to characterize fineness.

Fresh feed or raw mill feed. Stream of crushed yet not milled material that enters the cement mill. It is mainly composed of clinker particles but also gypsum and additions. Fresh feed particles enter the cement mill for the first time. These particles have a fineness defined by wherein 50 wt. %, preferably 70 wt. %, even more preferably 80 wt. % or more of said particles are retained in a 1 mm sieve.

Return grits. Particles that have been processed in the mill but because of their size in the separator are returned to the mill's entrance to repeat the grinding process. This stream of material that returns to the mill from the separator is called the return grits. These particles are finer than the material passing the intermediate diaphragm (5) into the second chamber (6), having typically an approximate fineness where no more than 80 wt. % of the particles are retained on 45 μm sieve and not more than 50 wt. % of the particles are retained on a 90 μm sieve (Blaine comprised between 900 cm²/g and 1200 cm²/g.

Air Separator: equipment that separates dry particulate materials into two distinct size fractions, one above and the other below a defined cut-point which normally range from 1 micron to 300 micron; exploiting the fact that different particles can obtain different velocities when moving in a fluid under a certain force. Typically, the cutting occurs at 45 μm.

Air slide: it is an efficient and practical method used to convey bulk powder material. Using low pressure air, an aeration bed and a small incline (gravity) and is able to convey hundreds of tonnes of products over long distances.

Ball mill. Type of cement mill that rotates around a horizontal axis, partially filled with the material to be ground plus the grinding medium (for example, steel balls). Ball mills work through impact and attrition, where the size reduction of particles is done by impact as the balls drop from near the top of the shell into the particles. These mills can have one chamber (single-chamber ball mill), two chambers (two-chamber ball mill) or more than two (multi-chamber ball mill). The ball mill according to the present invention is preferably a two-chamber ball mill.

Ball mill's first chamber. In the case of a two- or multi-chamber ball mills, the compartment that receives the particles coming from the fresh feed and return grits is called the first chamber. Known as well as coarse grinding.

Ball mill's second chamber. The compartment that receives particles from the first chamber is called the second chamber. Known as well as fine grinding.

Ball mill's diaphragm. Piece of equipment that separates the ball mill into two (or more) compartments, so that particles of different sizes, as well as different size grinding medium don't mix together, as each compartment is filled with different ball charges and sizes.

Heteroatom. An heteroatom is any atom that is not carbon or hydrogen. The term is used to indicate that non-carbon atoms have replaced carbon in the backbone of the molecular structure. Typical heteroatoms are nitrogen or oxygen, but this is not excluding any other elements.

Strength development-setting/hardening. The setting time starts when the construction material changes from plastic to rigid. In the rigid stage the material cannot be poured or moved anymore. After this phase the strength development corresponds to the hardening of the material.

Strength loss. Loss in the development of strength.

Particle dispersion. Particles are said to be dispersed when they are distributed in a continuous phase of another material.

Mill critical speed. Speed at which the centrifugal forces equal gravitational forces at the mill's internal surface. When the critical speed is 100%, the balls will just centrifuge, rotating with the mill, without grinding any particle.

### BRIEF DESCRIPTION OF THE FIGURES

FIG. 1 is a schematic representation of a ball mill with 2 chambers.

FIG. 2 is a schematic representation of the 3 methods followed in Example 2.

### EXAMPLES

### Example 1: Material & Methods

Table 1 and Table 2 respectively list the first and second grinding aids system families according to the method of the invention.

The grinding aids listed in Table 1 belong to a family of first grinding aids system. Each molecule in Table 1 can be added individually or in any combination with other molecules from Table 1. The grinding agents that comprise the first grinding agent system are characterized in that they have a molecular weight above 110 g/mol and have 4 or more heteroatoms.

The grinding aids listed in Table 2 belong to a family of second grinding aids system. Each molecule in Table 2 can be added individually or in any combination with other molecules from Table 2. The grinding agents that comprise the second grinding agent system are characterized in that they have a molecular weight between 46 g/mol and 110 g/mol and they have a maximum of 3 heteroatoms.

TABLE 1
Examples of possible first grinding agents
Molecular weight

| | | Molecular weight | |
|---|---|---|---|
| Name of Component | Formula | (g/mol) | Molecular structure |
| Glycerol ethox E01 | | 135 | 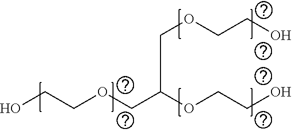 |
| Triethanolamine (TEA) | C₆H₁₅NO₃ | 149.18 | 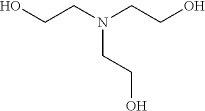 |
| Triethylene glycol (TEG) | C₆H₁₄O₄ | 150.17 | 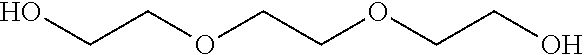 |
| Diacetin | C₇H₁₂O₅ | 176.17 | 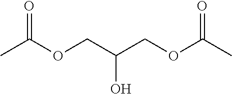 |
| Glucose | C₆H₁₂O₆ | 180.156 | 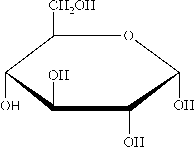 |
| Triisopropanolamine (TIPA) | C₉H₂₁NO₃ | 191.27 | 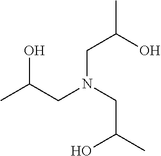 |
| Diethanol Isopropanolamine (DEIPA) | C₇H₁₇NO₃ | 163.22 | 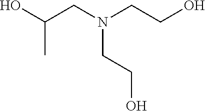 |
| Gluconic Acid | C₆H₁₂O₇ | 196.16 | 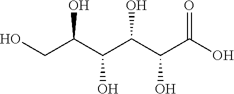 [SMILES: O=C(O)[C@H](O)[C@@H](O)[C@H](O)[C@H](O)CO] |

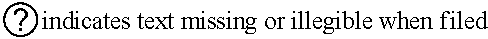

TABLE 2
Examples of possible second grinding agents
Molecular weight

| Name of Component | Formula | Molecular weight (g/mol) | Molecular structure |
|---|---|---|---|
| Formic Acid (FA) | CH₂O₂ | 46.03 | 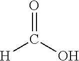 |
| Glyoxal | C₂H₂O₂ | 59.03 | 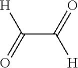 |
| Acetic Acid (AA) | C₂H₄O₂ | 60.05 | 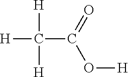 |
| Ethylene Glycol (EG) | C₂H₆O₂ | 62.07 | 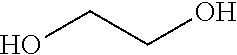 |
| Propionic Acid (PA) | C₃H₆O₂ | 74.08 | 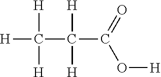 |
| 1,2-Propanediol PG | C₃H₈O₂ | 76.095 | 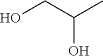 |
| Glycerol | C₃H₈O₃ | 92.09 | 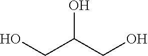 |
| Diethanolamine (DEA) | C₄H₁₁NO₂ | 105.14 | 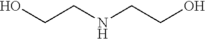 |
| Diethylene glycol (DEG) | C₄H₁₀O₃ | 106.12 | 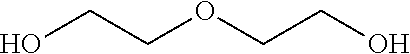 |

### Material Preparation

The clinker and gypsum, representative of fresh feed, were initially dried at 40° C. for 24 hours and then crushed on a jaw crusher with an aperture of 4 mm and pulverized using a disc pulverizer with a 2.7 mm aperture. The final material had a fineness characterized in that 3 wt. % or less are retained on a 4 mm sieve and 50 wt. %, preferably 70 wt. %, even more preferably 80 wt. % or more of said particles are retained in a 1 mm sieve.

Cement batches were then prepared. Every batch of cement had a total weight of 1300 g, with 95:5 clinker to gypsum ratio.

The grinding of the cement batches in all the examples was performed in a batch two-chamber ball mill with the following characteristics:

TABLE 3
Experimental Ball mill details
Bond ball mill details

| | |
|---|---|
| Internal diameter (m) | 0.3048 |
| Internal length (m) | 0.3048 |
| Mill speed (rpm) | 70 |
| Mill speed (fraction of critical speed) | 0.91 |
| Ball load (% by volume) | 19.27 |
| Total mass of balls (g) | 21125 |
| Ball top size (mm) | 36.38 |
| Geometry of mill liner | Smooth |
| Grinding type | dry |

The samples' density was measured using a helium pycnometer in order to calculate the samples' Blaine.

### Example 2: Results

Seven cement batches were separately ground in the mill targeting a final cement fineness of 4000 cm²/g with 50 volume % of the particles smaller than 14 μm. Each batch to be ground entered a two-chamber ball mill through the mill fresh feed chute and the ball mill was started. An equilibrium was reached with a blend of 66 wt % of returned material and 34 wt. % of fresh feed.

In order to test the theory hereby presented, three different experiments were done for each combination of first and second grinding systems: a reference, where the test was carried out as it is currently performed by the man skilled in the art, with both grinding aids added together in the mill feed; an “Experiment I” done according to the invention, where the first grinding aid has molecular weight above 110 g/mol and has 4 or more heteroatoms and it is added in the ball mill's feed and the second grinding aid has a molecular weight between 46 g/mol and 110 g/mol and has a maximum of 3 heteroatoms and it is added in the return; and finally an “Experiment II”, where the second grinding system according to the invention is added in the ball mill's feed and the first grinding system is added in the return. “Experiment I” aims at demonstrating the advantage of the method hereby presented compared to the reference or “Experiment II”.

All grinding aids were dissolved in demineralized water to obtain 40 wt % by dried solid weight solutions, to provide better dispersion in cement and more accurate dosing. The total weight of grinding aid (first+second grinding agents) added was 0.6 wt. %. The specific grinding aids added, as well as the added weight ratios, are specified in Table 4.

To cement batch 1 no grinding aid was added.

To ensure conformity of the results, the grinding aid is added to the return when its fineness complies with not more than 1% of the particles are retained on and above a 1 mm sieve and not more than 50 wt. % of the particles are retained on and above a 90 μm sieve.

TABLE 4
Results for Example 2

| | | | | Fineness when adding | | N° rounds |
|---|---|---|---|---|---|---|
| | | | | 2^{nd} Grinding Aid to the | | needed to |
| | | | | return | | achieve |
| Cement | | | | ≤1% | ≤50% | 4000 |
| Batch | Type of | | | particles | particles | cm²/g |
| N° (#) | Experiment | 1^{st} GA System | 2^{nd} GA System | ≥1 mm | ≥90 μm | Blaine |
| 1 | Reference | N/A | N/A | N/A | N/A | 4500* |
| 2 | Reference | TEA (65 wt. %) + AA (35 wt. %) | | N/A | N/A | 3850 |
| 3 | Exp I | TEA (65 wt. %) | AA (35 wt. %) | YES | YES | 3658 |
| 4 | Exp II | AA (35 wt. %) | TEA (65 wt. %) | YES | YES | 4378 |
| 5 | Reference | TIPA (65 wt. %) + EG (35 wt. %) | | N/A | N/A | 3978 |
| 6 | Exp I | TIPA (65 wt. %) | EG (35 wt. %) | YES | YES | 3756 |
| 7 | Exp II | EG (35 wt. %) | TIPA (65 wt. %) | YES | YES | 4397 |

*the Blaine in Batch 1 was obtained without adding any grinding agents

### Example 3: Results

Ten cement batches were separately ground in the mill, targeting a final Blaine of 4000 cm²/g (50 volume % of the particles smaller than 14 μm). Except for cement batch 1, a first grinding aid system was added when the particles had a fineness characterized in that 50 wt. % or less of said particles pass through a 1 mm sieve.

After a certain number of rounds, the second grinding agent was added, in the return grits. Particle fineness was also measured at this spot.

All grinding aids were dissolved in demineralized water to obtain 40 wt % by dried solid weight solutions, to provide better dispersion in cement and more accurate dosing. The total weight of grinding aid (first+second grinding agents) added was 0.04 wt. %. The specific grinding aids added, as well as the added weight ratios, are specified in Table 5.

To cement batch 1 no grinding aid was added.

In cement batches 2, 6 and 8, both grinding agents were added simultaneously in the fresh feed, as it is currently done by the man of the art.

Table 5 shows, for each cement batch, the grinding agents added, when was the 2nd grinding aid system added (after how many rounds), if the fineness at the moment of adding the 2nd grinding aid system complied with “not more than 1% of the particles are retained on and above a 1 mm sieve” and with “not more than 50% of the particles are retained on and above a 90 μm sieve” and also, the number of rounds needed to achieve the target Blaine of 4000 cm²/g (50 volume % of the particles smaller than 14 μm).

TABLE 5
Grinding aids (GA) systems used in example 3

| | | | 2nd | | | |
|---|---|---|---|---|---|---|
| | | | grinding | Fineness when | | N° rounds |
| | | | aid | adding 2^{nd} Grinding | | needed to |
| | | | added after | Aid | | achieve |
| Cement | | | in the | ≤1% | ≤50% | 4000 |
| Batch | 1^{st} GA | 2^{nd} GA | return (nr | particles | particles | cm²/g |
| N° (#) | system | system | of rounds) | ≥1 mm | ≥90 μm | Blaine |
| 1 | N/A | N/A | N/A | N/A | N/A | 4500* |
| 2 | TEA (60 wt. %) | FA (25 wt. %) | 0 | N/A | N/A | 4200 |
| 3 | TEG (15 wt. %) | | 1600 | YES | YES | 4000 |
| 4 | | | 2400 | YES | YES | 4150 |
| 5 | | | 3200 | YES | YES | 4200 |
| 6 | DEIPA (50 wt. %) | DEA (25 wt. %) | 0 | N/A | N/A | 3800 |
| 7 | | PA (25 wt. %) | 800 | YES | YES | 3700 |
| 8 | | | 1600 | YES | YES | 3700 |
| 9 | TIPA (75 wt. %) | AA (25 wt. %) | 0 | N/A | N/A | 3900 |
| 10 | | | 800 | YES | YES | 3800 |

*the Blaine in Batch 1 was obtained without adding any grinding agents

It is observed that, with no grinding aid added, the particles need to turn 4500 times in order to achieve the targeted Blaine. Also, when the second grinding agent is added separately from the first grinding agent, in the returns, the number of rounds needed to achieve the targeted Blaine is reduced.

This reduction in the number of rounds needed translates into a benefit of ˜2 kWh/ton cement when separately adding the grinding aids systems. Adding both grinding agents together, as it is commonly done now, translates into a less efficient process.

### Example 4: Results

In this example, it was not the Blaine which had a fixed target value, but the number of rounds were fixed. The number of rounds was fixed to 3200 rounds and the Blaine was measured at the end.

A first grinding aid system was added when the particles had a fineness characterized in that 50 wt. % or less of said particles pass through a 1 mm sieve. In this example, the first grinding aid system was added in the fresh feed.

Again, the second grinding agent was added after a certain number of rounds, in the return grits. Particle fineness was also measured at this spot.

All grinding aids systems were dissolved in demineralized water to obtain 40 wt % by dried solid weight solutions, to provide better dispersion in cement and more accurate dosing. The total weight of grinding aid (first+second grinding agents) added was 0.02 wt. %. The specific grinding aids added, as well as the added weight ratios, are specified in Table 6.

In cement batches 1, 3 and 7, both grinding agents systems were added simultaneously in the fresh feed, as it is currently done by the man of the art.

Table 6 shows, for each cement batch, the grinding agents systems added, when was the 2^{nd} grinding aid system added (after how many rounds), if the fineness at the moment of adding the 2^{nd} grinding aid system complied with “not more than 1 wt. % of the particles are retained on and above a 1 mm sieve” and with “not more than 50 wt. % of the particles are retained on and above a 90 μm sieve” and also, the Blaine after 3200 rounds.

TABLE 6
Grinding aids (GA) systems used in example 4

| | | | 2nd | | | |
|---|---|---|---|---|---|---|
| | | | grinding | Fineness when | | |
| | | | aid | adding 2^{nd} | | |
| | | | added in | Grinding Aid | | Blaine |
| Cement | | | the return | ≤1% | ≤50% | after |
| Batch | 1^{st} GA | 2^{nd} GA | after (nr | particles | particles | 3200 |
| N° (#) | system | system | of rounds) | ≥1 mm | ≥90 μm | rounds |
| 1 | TIPA | AA | 0 | N/A | N/A | 3791 |
| 2 | (50 wt. %) | (50 wt. %) | 800 | YES | YES | 3867 |
| 3 | TIPA | AA | 0 | N/A | N/A | 3841 |
| 4 | (75 wt. %) | (25 wt. %) | 800 | YES | YES | 3909 |
| 5 | | | 1600 | YES | YES | 3911 |
| 6 | | | 2400 | YES | YES | 3836 |
| 7 | TIPA | AA | 0 | N/A | N/A | 3735 |
| 8 | (25 wt. %) | (75 wt. %) | 800 | YES | YES | 3850 |

Furthermore, the same grinding aids systems were used at a higher dosage. The following table (Table 7) shows the results using a total dosage of 1.0 wt. % (types of grinding aids used and respective weight ratios can be seen in Table 7). 5

TABLE 7
Grinding aids (GA) systems used in example 4

| | | | 2nd | | | |
|---|---|---|---|---|---|---|
| | | | grinding | Fineness when | | |
| | | | aid | adding 2^{nd} | | |
| | | | added after | Grinding Aid | | Blaine |
| Cement | | | in the | ≤1% | ≤50% | after |
| Batch | 1^{st} GA | 2^{nd} GA | return (nr | particles | particles | 3200 |
| N° (#) | system | system | of rounds) | ≥1 mm | ≥90 μm | rounds |
| 1 | TIPA | AA | 0 | N/A | N/A | 3851 |
| 2 | (50 wt. %) | (50 wt. %) | 800 | YES | YES | 3976 |

It is observed in all the cement batches that a much higher Blaine value can be achieved when first and second grinding agents systems are added separately than when added simultaneously, as currently done by the man skilled on the art.

To have a better idea about how to interpret the data and the impact on the energy efficiency when the Blaine increase with the same number of rounds, we must look to the following data (Christian Pfeiffer seminar 2019). To reach a fineness of 3,000-3,200 cm²/gr it is required about 32-35 kWh/ton depending on the material hardness and fineness; this was also confirmed by Seebach, 1996. However, in order to reach fineness above 3500 cm²/g to 4000 cm²/g the energy demand can be up to 5 Kwh/t for every increase of 100 cm²/g requiring about 55 Kwh/t for a 4000 cm²/g Blaine (50 volume % of the particles smaller than 14 μm). We confirm again that the savings by this method could be from 2-3 Kwh/t, which is consistent with the previous findings.

### Example 5: Results

This example shows that, only adding grinding agents from the same grinding aid family (either all chosen from Table 1 or from Table 2) does not bring any advantages to the grinding process, even when added separately. Again, the Blaine was targeted at 4000 cm²/g (50 volume % of the particles smaller than 14 μm) and the number of rounds needed to reach this value was registered.

All grinding aids were dissolved in demineralized water to obtain 40 wt % by dried solid weight solutions, to provide better dispersion in cement and more accurate dosing. The total weight of grinding aid (first+second grinding agents) added was 0.04 wt. %. The specific grinding aids added, as well as the added weight ratios, are specified in Table 8.

In cement batches 7-10, TEA was correctly added as a first grinding aid system and EG as a second grinding agent system, but in cement batches 8-10, EG was added in parts of the process where the desired fineness was not verified.

TABLE 8
Grinding aids (GA) used in example 5

| | | | 2nd | | | N° |
|---|---|---|---|---|---|---|
| | | | grinding | Fineness when | | rounds |
| | | | aid | adding 2^{nd} | | needed to |
| | | | added in | Grinding Aid | | achieve |
| Cement | | | the return | ≤1% | ≤50% | 4000 |
| Batch | | | after (nr | particles | particles | cm²/g |
| N° (#) | 1^{st} GA | 2^{nd} GA | of rounds) | ≥1 mm | ≥90 μm | Blaine |
| 1 | DEIPA | TEA | 0 | N/A | N/A | 4100 |
| 2 | (50 wt. %) | (50 wt. %) | 800 | YES | YES | 4250 |
| 3 | TEA | Glucose | 0 | N/A | N/A | 4200 |
| 4 | (75 wt. %) | (25 wt. %) | 800 | YES | YES | 4300 |
| 5 | EG | AA | 0 | N/A | N/A | 4105 |
| 6 | (75 wt. %) | (25 wt. %) | 800 | YES | YES | 4200 |
| 7 | TEA | EG | 800 | YES | YES | 3900 |
| 8 | (50 wt. %) | (50 wt. %) | 500 | NO | YES | 4112 |
| 9 | | | 600 | YES | NO | 4078 |
| 10 | | | 300 | NO | NO | 4100 |

According to Table 8 there is no benefit in adding molecules belonging to the same Grinding Aid System Family to the grinding process, even when adding them separately. Also, the fineness of the particles when adding the second grinding agent system plays an important role. It is easily concluded that, following the method described hereby can bring great benefits to the grinding energy and process efficiency.

### Example 6: Results

This example aimed at comparing the addition of the second grinding system in the return grits from the separator (15) versus adding it in the second chamber.

Again, the Blaine was targeted at 4000 cm²/g (50 volume % of the particles smaller than 14 μm) and the number of rounds needed to reach this value was registered.

All grinding aids were dissolved in demineralized water to obtain 40 wt % by dried solid weight solutions, to provide better dispersion in cement and more accurate dosing. The total weight of grinding aid (first+second grinding agents) added was 0.8 wt. %. The specific grinding aids added, as well as the added weight ratios, are specified in Table 9.

In cement batches 1 and 3, the second grinding system was added in the return grits from the separator (15), following the invention hereby described. In cement batches 2 and 4, the second grinding system was added in the second chamber of the ball mill.

TABLE 9
Grinding aids according to Example 6

| | | | 2^{nd} Grinding Aid | | No rounds |
|---|---|---|---|---|---|
| Cement | | | added in: | | needed to |
| Batch | | | Return | 2^{nd} | achieve 4000 |
| No (#) | 1^{st} GA | 2^{nd} GA | Grits | Chamber | cm²/g Blaine |
| 1 | Glucose | Glyoxal | X | | 3900 |
| 2 | (50 wt. %) | (50 wt. %) | | X | 4104 |
| 3 | TEA | EG | X | | 4014 |
| 4 | (25 wt. %) | (75 wt. %) | | X | 4112 |

According to Table 9 there is a benefit in adding the second grinding aid to the return grits from the separator (15) versus adding it into the second chamber.

By first and second grinding aid, it should be understood any chemical or chemical combination according to Table 1 and Table 2.

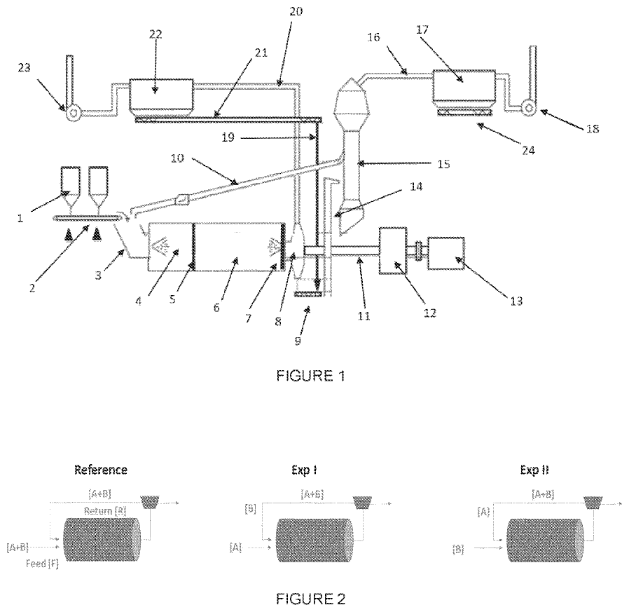

According to another embodiment of the invention and with reference to FIG. 1 for a 2 chambers ball mill, the first grinding aid or grinding aids system (characterized in that they have a molecular weight above 110 g/mol and has 4 or more heteroatoms) is preferably added and dosed in the conveying belt of the fresh feed (2). Alternatively, the addition of the first grinding aid system can be done in the mill fresh feed chute (3) prior entering the ball mil, provided that the fineness of the material receiving the grinding aid is verified, or simultaneously in both the conveying belt of the fresh feed (2) and in the mill fresh feed chute (3) prior entering the ball mill. 5 The second grinding aid or grinding aid system (characterized in that they have a molecular weight between 46 g/mol and 110 g/mol and they have a maximum of 3 heteroatoms where at least one of them should be oxygen) according to the invention is typically added and dosed to the material that is returning to the ball mill, via the return grits from the separator (15), where the fineness of the material meets the required condition of fineness (not more than 1 wt. % of the 10 particles are retained on and above a 1 mm sieve and not more than 50 wt. % of the particles are retained on and above a 90 μm sieve).

1. Method to increase the grinding efficiency of a fresh feed during cement manufacturing process, comprising:
a) Providing a fresh feed to a multi-chamber cement ball mill.
b) Adding a first grinding agent system to the fresh feed, wherein the fresh feed's particles have a fineness characterized in that 50% or less of said particles pass through a 1 mm sieve;
c) Adding a second grinding agent system, which is different from the first grinding agent system to the return grits in the grits return line, wherein the grinding agents that comprise the second grinding agent system added in step c) are characterized in that they have a molecular weight between 46 g/mol and 110 g/mol and they have a maximum of 3 heteroatoms where at least one of them is oxygen;
d) Grinding the material obtained in step b) and c) until the material reaches a fineness characterized in that not more than 1 wt. % of the particles are retained on a 1 mm sieve and not more than 50 wt. % of the particles are retained on a 90 μm sieve;
e) Further grinding the material obtained in step d) until the material reaches a fineness of 40 wt. % retained on a 45 μm sieve.

2. Method to increase the grinding efficiency of a fresh feed during cement manufacturing process, comprising:
a) Providing a fresh feed to a multi-chamber cement ball mill;
b) Adding a first grinding agent system and a second grinding agent system, which is different from the first grinding agent system, to the fresh feed;
wherein the fresh feed's particles have a fineness characterized in that 50% or less of said particles pass through a 1 mm sieve; and
wherein the grinding agents that comprise the second grinding agent system are characterized in that they have a molecular weight between 46 g/mol and 110 g/mol;
c) Optionally adding the second grinding agent system to the grits return in the grits return line;
d) Grinding the material obtained in step b) and optionally in step c) until the material reaches a fineness characterized in that not more than 1 wt. % of the particles are retained on a 1 mm sieve and not more than 50 wt. % of the particles are retained on a 90 μm sieve;
e) Further grinding the material obtained in step d) until the material reaches a fineness of 40 wt. % retained on a 45 μm sieve.

3. Method according to claim 1, wherein the grinding agents that comprise the first grinding agent system added in step b) are characterized in that they have a molecular weight above 110 g/mol and have 4 or more heteroatoms where at least one of them is oxygen.

4. Method according to claim 1, wherein the first grinding agent system is added in step b) in a dosage between 0.01% and 0.5% by weight of the particles to be ground.

5. Method according to claim 1, wherein the second grinding agent system is added in a dosage between 0.01% and 0.5% by weight of the particles to be ground.

6. Method according to claim 1, wherein the total weight % of the said first and/or second grinding agent systems is added to the fresh feed in the weight feeder/conveyor belt(s) and/or in the mill fresh feed chute.

7. Method according to claim 1, wherein the total weight % of the said first and second grinding agent systems is between 0.02% and 1.0% by weight of the total particles to be ground.

8. Method according to claim 1, wherein the grinding of step d) and further grinding of step e) is carried out into the first and second chamber, respectively, of a two-chamber cement ball mill.
